(19) United States
(12) Patent Application Publication
(10) Pub. No.: US 2016/0049902 A1
(43) Pub. Date: Feb. 18, 2016

(54) METHOD AND DEVICE FOR CONTROLLING THE TEMPERATURE OF PHOTOVOLTAIC PANELS

(71) Applicant: SUNID, Aussonne (FR)

(72) Inventors: Nicolas CRISTI GONZALEZ, Cornebarrieu (FR); André MACQ, Howald (LU)

(73) Assignee: SUNID, Aussonne (FR)

(21) Appl. No.: 14/771,254

(22) PCT Filed: Mar. 3, 2014
(86) PCT No.: PCT/FR2014/050459

§ 371 Date: Oct. 30, 2015

(30) Foreign Application Priority Data
Mar. 1, 2013 (FR) 1351860

(51) Int. Cl. H02S 40/42; H02S 50/00

(52) U.S. Cl. CPC H02S 40/425; H02S 50/00

(57) ABSTRACT

A method for the thermal regulation of photovoltaic panels exposed to the wind and comprising a plurality of devices for the spraying of a cooling liquid suitable for spraying the liquid onto the photovoltaic panels, the method being characterized in that it comprises the steps consisting in:
measuring a temperature of at least one panel;
measuring the wind speed;
activating the spraying of at least one of the spraying devices;
deactivating the spraying of all or a part of the spraying devices.

The method is such that the activation, deactivation and/or spray pressure, of some of the spraying devices are controlled relative to the measured wind speed.

Device for the implementation of this method.

### FIELD OF THE INVENTION

The present invention concerns methods and devices for thermal regulation. It is related to the field of photovoltaics. More specifically, it concerns methods and devices allowing to adjust the temperature of photovoltaic panels.

### BACKGROUND

The photovoltaic exploitation of solar energy consists in directly converting solar radiation into electricity. To do this it uses photovoltaic panels to perform this energy transformation. However, with a maximum conversion currently in the region of 15%, this energy is mostly dissipated as heat for about 80%, while the remaining energy is reflected away for about 5%. Because of this, during the summer for example, the temperature of a photovoltaic panel can rise to over 70° C.

It is known that such an increase in the temperature of a photovoltaic panel results in particular in a decrease in the electrical power measured at the output of the panel but also in a shift of the maximum power point of the photovoltaic panel. Under these conditions, a loss in conversion efficiency situated between 14% and 39% can be observed.

In this way, in the absence of a suitable regulation system, the operating temperature of a photovoltaic panel can cause a significant loss in efficiency.

It is known to lower the temperature of photovoltaic panels by flowing a liquid over a photovoltaic system in which the photovoltaic panels are arranged edge to edge in vertical and/or horizontal rows following, for example, the slope of a roof. To do this, a liquid, water for example, is applied from the highest part of the photovoltaic system, onto the surface of the photovoltaic panels. The liquid therefore flows from one photovoltaic panel to another until it reaches the lowest part of the photovoltaic system.

This solution requires a photovoltaic system comprising photovoltaic panels arranged contiguously along the vertical and/or horizontal rows following, for example, the slope of a roof, so that the lower edge of a higher photovoltaic panel covers the upper edge of a lower photovoltaic panel in a row or a seal completes and unifies the plane formed by the panels so that the flow will continue over all of the photovoltaic panels. However, most photovoltaic systems comprise photovoltaic panels with a spacing in the region of one or more centimeters between the photovoltaic panels taken two at a time, mainly for practical reasons related to the mounting techniques and accessories that are most widely used on the market. Furthermore, this solution requires the panels of the photovoltaic system to be arranged at a sufficient angle to enable the flow of water over the panels. For these reasons, the solution of cooling by liquid flow is not applicable to all types of photovoltaic systems.

It is also known to lower the temperature of a photovoltaic panel by atomizing a liquid onto the upper surface of the photovoltaic panel, as described for example in document FR2977981. However, this solution is only efficient in the almost total absence of wind. Indeed, in the presence of wind, even relatively very slight, the liquid particles generated by atomization are mostly blown away by the wind before they are able to lower the temperature of the ambient air or come into contact with the surface of the photovoltaic panel in order to lower its temperature.

### SUMMARY OF THE INVENTION

The present invention aims to overcome the disadvantages of the prior art by proposing a method and a device for the thermal regulation of photovoltaic panels in the presence of wind.

Moreover, the present invention can be advantageously adapted to the majority of photovoltaic systems comprising photovoltaic panels.

For this purpose, according to the invention, the aim is a method for the thermal regulation of a plurality of photovoltaic panels exposed to the wind and comprising a plurality of liquid spraying devices suitable for applying a cooling liquid onto the plurality of panels. The method is characterized in that it comprises in particular the steps consisting in:
measuring a temperature of at least one panel;
measuring the speed of the wind;
activating the spraying of at least one of the liquid spraying devices when:
   the measured temperature is higher than or equal to a predetermined first temperature value; and,
   the measured wind speed is less than or equal to a predetermined first windspeed value;
deactivating the spraying of all or a part of the liquid spraying devices when:
   the measured temperature is lower than or equal to a predetermined second temperature value, which is lower than the predetermined first temperature value; and,
   the measured wind speed is greater than or equal to a predetermined second windspeed value, which is greater than the predetermined first windspeed value;
      the method being such that the activation, deactivation and/or spray pressure of some of the liquid spraying devices are controlled relative to the measured wind speed.

Thanks to these arrangements, cooling depends on the speed of the wind and the operating temperature of the panel.

In this way, the cooling liquid can be used when a certain wind speed is measured so that the droplets formed by spraying of the liquid can be applied onto the plurality of the photovoltaic panels even in the presence of wind.

In an embodiment of the invention:
activation of the spraying of at least some of the liquid spraying devices is also triggered if a measurement of a physical parameter at the level of the plurality of panels is greater than a predetermined first value of the physical parameter; and,
deactivation of the spraying of at least some of the liquid spraying devices is also triggered if the measurement of the physical parameter is less than or equal to a predetermined second value of the physical parameter, which is less than the predetermined first value of the physical parameter. In this embodiment, the physical parameter is part of a group comprising:
the amount of sunlight received at the level of the plurality of panels;
the amount of electricity produced by at least one panel; and,
the electrical current and/or voltage of at least one electrical device operatively coupled to at least one panel.

It is advantageous to take into account certain physical parameters in order for example to only activate spraying when the knowledge of these physical parameters makes spraying useful or efficient, and/or in order to prevent any damage that might be caused by the spraying. For example, it is advantageous to take into account the presence or absence of sunlight and/or its intensity to encourage the natural cooling of the photovoltaic panels and at the same time save cooling liquid. It is also advantageous to take into account the electrical behavior of the items of electrical equipment connected to the plurality of panels.

In another embodiment of the invention, the method can additionally comprise the step consisting in:
measuring the direction of the wind;
   the method being such that in addition:
the activation, deactivation and/or spray pressure of at least some of the liquid spraying devices are controlled relative to the measured wind direction.

It is advantageous to be able to take into account the direction of the wind in order, for example, not to activate the liquid spraying devices which are too exposed to the wind or in order not to activate the liquid spraying devices which are, in the maritime sense of this expression, “leeward” (downwind) of the photovoltaic panels. Cooling liquid can in this way be saved.

In an embodiment of the invention:
activation of the spraying of at least some of the liquid spraying devices is also triggered if the difference between, on the one hand the measured temperature of at least one panel and on the other hand a measurement of the ambient air temperature at the level of the plurality of panels and/or a measurement of the temperature of the cooling liquid before spraying is less than a predetermined first difference value; et,
deactivation of the spraying of at least some of the liquid spraying devices is also triggered if the difference between, on the one hand the measured temperature of at least one panel and on the other hand a measurement of the ambient air temperature at the level of the plurality of panels and/or the measurement of the temperature of the cooling liquid after spraying is greater than or equal to a predetermined second difference value, which is greater than the predetermined first difference value.

It is advantageous to be able to take into account the temperature of the cooling liquid in order for example to prevent abundant spraying of very cold liquid from subjecting the photovoltaic panels to a severe thermal shock.

It is also advantageous to be able to take into account the ambient air temperature in order for example to minimize the evaporation of the droplets moving through the air during spraying.

In one of the embodiments of the invention:
activation of the spraying of at least some of the liquid spraying devices can be also triggered if a measurement of the atmospheric water precipitation rate at the level of the plurality of panels is less than a predetermined first precipitation rate value; and,
deactivation of the spraying of at least some of the liquid spraying devices can also be triggered if the measurement of the precipitation rate at the level of the plurality of panels is greater than a predetermined second precipitation rate value, which is greater than the predetermined first precipitation rate value.

It is advantageous to be able to take into account the atmospheric water precipitation rate, for example to encourage the natural cooling of the photovoltaic panels and/or to prevent the mixing of rainwater with the cooling liquid.

In another embodiment of the invention, the measurement of the temperature of at least one photovoltaic panel can consist in making at least one measurement above and at least one measurement underneath the panel.

It is advantageous to be able to take into account the temperatures above and/or underneath the panel, for example, in order to determine the thermal inertia of the panel and to adapt accordingly the spraying mode.

In an embodiment of the invention, the speed and the direction of the wind can be measured for a predefined period of time in order to determine statistical values for the wind.

In another embodiment of the invention, it is possible to determine one or more activation and/or deactivation moments for spraying and the spray pressure for at least some of the spraying devices based on an algorithm to search for peaks and troughs in a model of the wind speed and/or wind direction.

It is advantageous to be able to detect and/or predict the peaks and troughs and the direction of the wind in order to allow an economical use of cooling liquid.

In one of the embodiments of the invention, in cases where the panels of the plurality of photovoltaic panels are clearly spaced apart, i.e. separated from each other by a space of for example a few centimeters for technical reasons related to the construction of such assemblies, it is then possible to arrange the spraying devices in this space.

It is advantageous to be able to arrange the spraying devices in the space situated between the photovoltaic panels, and/or on the periphery of a plurality of photovoltaic panels, in order for example to avoid any shading effect, and therefore loss of electrical energy, caused by a device mounted on the surface of the photovoltaic panels.

The invention also relates to a device for the thermal regulation of a plurality of photovoltaic panels exposed to the wind and comprising a plurality of liquid spraying devices suitable for applying a cooling liquid onto the plurality of panels. The device comprises:
means for measuring the temperature of at least one photovoltaic panel;
means for measuring the speed of the wind;
means for activating at least one liquid spraying device;
means for deactivating at least one spraying device;
means for controlling the pressure of at least one spraying device in relation to the measured wind speed; and,
a microcontroller coupled to at least one of the means for:
   measuring the temperature of at least one photovoltaic panel;
   measuring the speed of the wind;
   activating at least one liquid spraying device;
   deactivating at least one spraying device; and,
   controlling the pressure of at least one spraying device in relation to the measured wind speed.

In an embodiment of the invention, the device can additionally comprise, coupled to the microcontroller, at least one of the means for:
measuring the amount of sunlight received at the level of the plurality of panels;
measuring the amount of electricity produced by at least one panel;
measuring the electrical current and/or voltage delivered or absorbed by at least one panel.

In this embodiment:
activation of the spraying of at least some of the liquid spraying devices is also triggered if a measurement of a physical parameter at the level of the plurality of panels is greater than a predetermined first value of the physical parameter; and,
deactivation of the spraying of at least some of the liquid spraying devices is also triggered if the measurement of the physical parameter is less than or equal to a predetermined second value of the physical parameter, which is less than the predetermined first value of the physical parameter. Moreover, in this embodiment, the physical parameter is part of a group comprising:
the amount of sunlight received at the level of the plurality of panels;
the amount of electricity produced by at least one panel; and,
the electrical current and/or voltage of at least one electrical device operatively coupled to at least one panel.

In another embodiment of the invention, the device can additionally comprise:
means for measuring the direction of the wind; and,
means for controlling the activation, deactivation and/or pressure of at least one spraying device in relation to the measured wind direction.

In an embodiment of the invention, the device can additionally comprise at least measuring means belonging to the group comprising:
means for measuring the ambient air temperature at the level of the plurality of panels;
means for measuring the temperature of the cooling liquid; and,
means for measuring the atmospheric water precipitation rate at the level of the plurality of panels.

In another embodiment of the invention, the device can additionally comprise means for storing of at least one of the measurements obtained by the measurement means.

In one of the embodiments of the invention, the spraying devices are for example coupled to one or more hydraulic conduits allowing to convey a cooling liquid and belonging to a hydraulic system.

### BRIEF DESCRIPTION OF THE DRAWINGS

Other embodiments, uses and advantages of the invention will be apparent from the following description of an embodiment of the invention, given by way of non-limiting example, with reference to the accompanying drawings in which:

FIG. 1 schematically shows an example of a photovoltaic system;

FIG. 2 schematically shows a plurality of photovoltaic panels associated with a cooling device according to the invention;

FIG. 3 schematically shows a diagram illustrating an implementation of the method by the cooling device according to an embodiment of the invention; and,

FIG. 4 schematically shows a diagram illustrating an implementation of the method by the cooling device according to another embodiment of the invention.

### DETAILED DESCRIPTION THE INVENTION

It is considered that the devices and operating principles of a photovoltaic panel and of photovoltaic systems are known to those skilled in the art and will therefore not be described in more detail here.

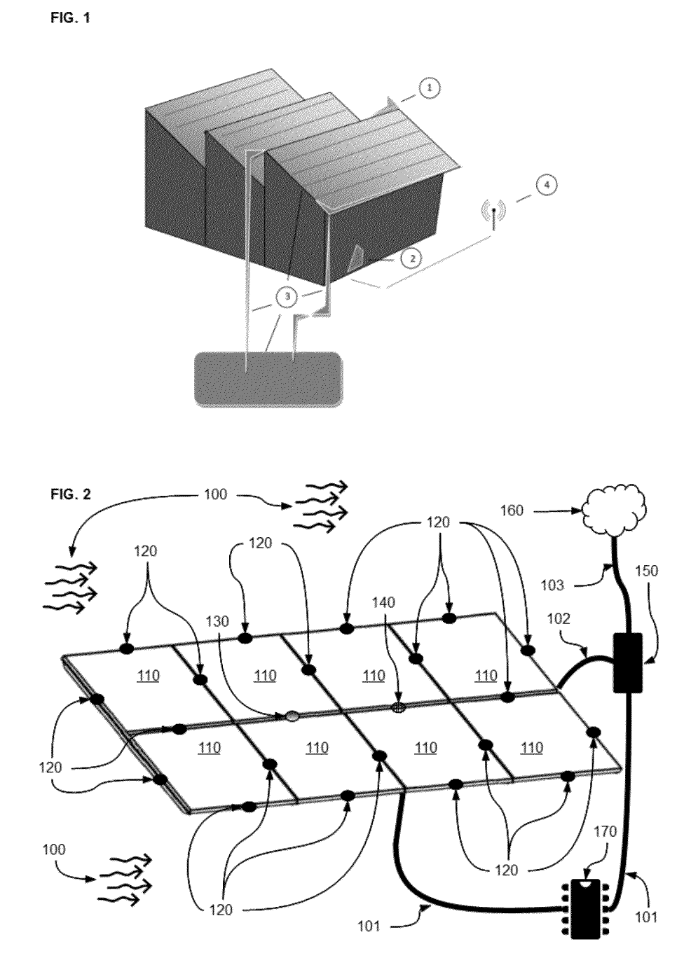

FIG. 1 schematically shows an example of a photovoltaic system installed on a roof of a factory, the photovoltaic system comprising:
a set of probes 1 such as those described below;
a thermal regulator 2 such as the one described according to the invention hereafter;
a hydraulic system 3 suitable for circulating a liquid; and,
a communication system 4 suitable for circulating or retrieving at least one item of information corresponding to data handled by the thermal regulator.

In the example of FIG. 1, the hydraulic system 3 comprises a set of pumps, pressure regulators, filters and elements for the storage of the cooling liquid. However, the hydraulic system 3 can also comprise other elements.

In the example of FIG. 1, the communication system 4 comprises a user interface to control the regulator, means for programming the regulator and means for connecting to an electrical or telephone network. However, the communication system 4 can also comprise other communication elements.

The example of the device in FIG. 2 comprises:
a plurality of photovoltaic panels 110;
a plurality of liquid spraying devices 120;
a temperature sensor 130;
a windspeed sensor 140;
an inverter 150; and,
a control unit such as a microcontroller 170.

Referring to FIG. 2, the photovoltaic panels 110 are arranged edge to edge in vertical and/or horizontal rows following the slope of the roof of the factory and are separated from each other by a space when the photovoltaic panels are taken two at a time. In this example, the plurality of liquid spraying devices 120 face each other on a horizontal or vertical axis so that there is a spraying device on each edge of the photovoltaic panels 110.

A liquid spraying device 120 can have a nozzle and an adjustment element allowing to adjust the flow of liquid passing through the outlet of the nozzle.

The plurality of liquid spraying devices 120 is configured to apply a cooling liquid onto the plurality of photovoltaic panels 110. For example, the cooling liquid can be rainwater collected in a tank coupled to a hydraulic system 3.

The plurality of liquid spraying devices 120 is coupled to an interface 101 allowing to provide a link with the microcontroller 170 as well as the control of the plurality of liquid spraying devices 120 by the latter.

Referring to FIG. 2, the temperature sensor 130 is configured to measure the operating temperature of the plurality of photovoltaic panels 110.

In the example of FIG. 2, the temperature sensor 130 is associated with the plurality of photovoltaic panels 110 so as to measure their operating temperatures. The temperature sensor 130 is coupled to the interface 101 allowing to provide a link with the microcontroller 170 as well as the control of the temperature sensor 130 by the latter.

Referring to FIG. 2, the windspeed sensor 140 is configured to measure the speed of the wind to which the plurality of photovoltaic panels 110 is exposed. In this example, the windspeed sensor 140 is associated with the plurality of photovoltaic panels 110 so as to measure the speed of the wind to which the panels are respectively exposed. The windspeed sensor 140 is coupled to the interface 101 allowing to provide a link with the microcontroller 170 as well as the control of the windspeed sensor 140 by the latter.

Referring to FIG. 2, the inverter 150 is configured to convert the direct current generated by the plurality of photovoltaic panels 110 into a suitable alternating current. This is because photovoltaic panels produce direct current electricity like batteries do, and not like that of the mains supply, which is in France, for example, an alternating current at a frequency of 50 Hz. Therefore, in order to supply devices with alternating current or to connect up to the mains supply in order to inject into it the electricity produced from the photovoltaic energy, an inverter 150 is used to perform this conversion operation.

In the example of FIG. 2, the inverter 150 is associated with the plurality of photovoltaic panels 110 through the coupling interface 102 so as to convert the current that they have respectively generated. It is clear to those skilled in the art that the coupling interface 102 is configured to convey a direct current generated by the plurality of photovoltaic panels 110. The inverter 150 is coupled to the interface 103 allowing to convey the converted current to the mains 160 or to one or more electrical devices. It is clear to those skilled in the art that the coupling interface 103 is configured to convey an alternating current converted by the inverter 150. The inverter 150 is also coupled to the interface 101 allowing to provide a link with the microcontroller 170 as well as the monitoring and/or control of the inverter 150 by the latter.

According to the invention, the link between the microcontroller 170 and the plurality of liquid spraying devices 120, the temperature sensor 130, the windspeed sensor 140 and/or the inverter 150 can be a physical link of the wire or optical type, for example through the use of a bus according to the Modbus or Ethernet standard. Alternatively, the link can be a wireless link, for example by radiofrequency.

Referring to FIG. 2, the microcontroller 170 is configured to exchange one or more data signals with:
the plurality of liquid spraying devices 120;
the temperature sensor 130;
the windspeed sensor 140; and
the inverter 150.

For example, the exchange of data signals with the liquid spraying devices 120 allows the microcontroller 170 to control the adjustment element allowing to adjust the flow of liquid passing through the outlet of a nozzle.

The microcontroller 170 is also configured to retrieve one or more measurements of the operating temperature of one or more photovoltaic panels, measurements made by the temperature sensor 130 thanks, for example, to the transmission of data signals to the temperature sensor 130 or thanks to the continuous or periodical transmission of the measured temperature to the microcontroller 170.

It is also possible, for example, for the microcontroller 170 to retrieve one or more measurements of the speed of the wind, measurements made by the windspeed sensor 140, to which one or more photovoltaic panels are exposed thanks, for example, to the transmission of data signals to the windspeed sensor 140 or thanks to the continuous or periodical transmission to the microcontroller 170 of the measurement of the wind speed.

The microcontroller 170 can also retrieve one or more measurements of the amount of electricity produced by one or more photovoltaic panels, measurements made for example at the output of the panel or by the inverter 150, thanks, for example, to the transmission of data signals to the inverter 150 or thanks to the continuous or periodical transmission to the microcontroller 170 of the measured amount of electricity produced.

Moreover, the microcontroller 170 is configured to execute instructions coming for example from a storage medium such as a memory or a read-only memory of a personal computer (PC).

More specifically, the microcontroller 170 is configured to perform at least one of the operations described below according to one or more embodiments of the invention.

An embodiment of the invention provides for the thermal regulation of a plurality of photovoltaic panels 110 exposed to the wind 100.

It is known that the wind 100 causes, by dispersal, a loss of a liquid atomized over the plurality of photovoltaic panels 110 even before the water particles generated by atomization have been able to lower the temperature of the ambient air or come into contact with the surface of the plurality of photovoltaic panels 110 in order to lower their temperature. However, by using droplets of cooling liquid generated for example by spraying and which are substantially larger than the water particles generated by atomization, it is possible to increase the cooling capacity of the cooling liquid by which the surface of the plurality of photovoltaic panels has effectively been wetted. This is because the wind 100 facilitates the evaporation of the cooling liquid which occurs mainly after the cooling liquid comes into contact with the surface of the plurality of photovoltaic panels 110. This phenomenon results in a change of state which consumes calories and therefore has a cooling effect on the surface of the plurality of photovoltaic panels 110.

Therefore, one of the objects of the invention is to provide thermal regulation of the plurality of photovoltaic panels 110 thanks to the spraying of a cooling liquid in a suitable manner based on at least one or more measurements of the speed of the wind to which the plurality of photovoltaic panels 110 is exposed, without causing significant losses of cooling liquid due to the phenomenon of dispersal.

To do this, the thermal regulation device comprises:
the plurality of liquid spraying devices 120, suitable for applying a cooling liquid onto the plurality of panels 110;
the temperature sensor 130 suitable for measuring at least one operating temperature of the plurality of panels 110;
the windspeed sensor 140 suitable for measuring at least one speed of the wind to which the plurality of panels 110 is exposed; and,
the microcontroller 170 coupled through the interface 101 to the plurality of liquid spraying devices 120, to the temperature sensor 130 and to the windspeed sensor 140.

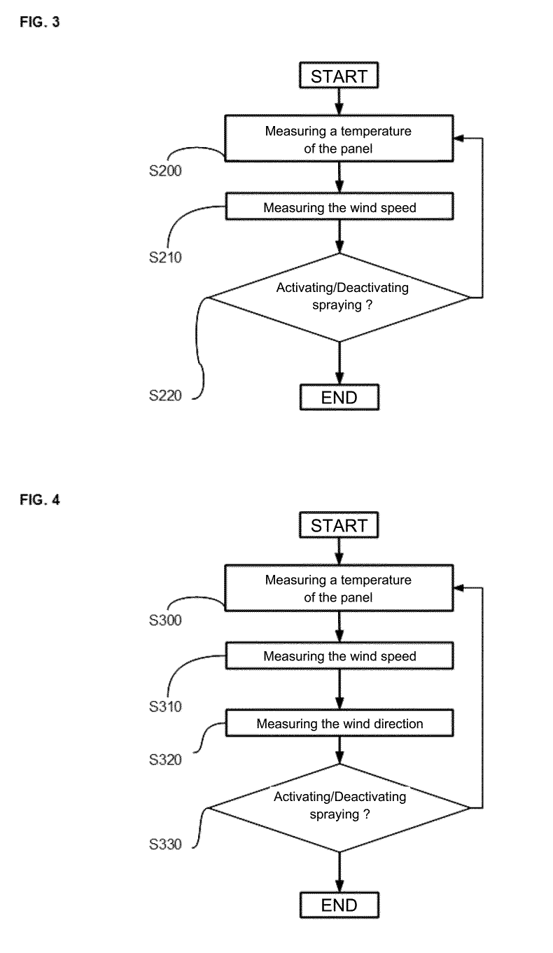

The device is configured to implement a method for the thermal regulation of the plurality of panels 110 illustrated by all of the steps described in figure FIG. 3.

In a first step (S200), at least one temperature of at least one photovoltaic panel 110 is measured, using the temperature sensor 130 for example. The frequency of the measurement can, for example, be controlled by the microcontroller 170.

In a second step (S210), it is measured the speed of the wind to which the plurality of photovoltaic panels 110 is exposed, using the windspeed sensor 140 for example. The frequency of the measurement can, for example, be controlled by the microcontroller 170.

In a third step (S220), the decision is made to activate or deactivate the spraying of at least one of the liquid spraying devices 120, thanks to the microcontroller 170 for example. More specifically, it is possible to activate the spraying of at least one of the liquid spraying devices 120 when:
the measured temperature is higher than or equal to a predetermined first temperature value; and,
the measured wind speed is less than or equal to a predetermined first windspeed value.

For example, a predetermined first temperature value can be situated at around 30° C. and a predetermined first windspeed value can be situated at around 0 m/s.

It is also possible to deactivate the spraying of all or a part of the liquid spraying devices 120 when:
the measured temperature is lower than or equal to a predetermined second temperature value, which is lower than the predetermined first temperature value; and,
the measured wind speed is greater than or equal to a predetermined second windspeed value, which is greater than the predetermined first windspeed value.

For example, a predetermined second temperature value can be situated at around 25° C. and a predetermined second windspeed value can be situated at around 5 m/s.

In order to activate or deactivate all or a part of the liquid spraying devices 120, the device is configured to control the activation, deactivation and/or spray pressure of some of the liquid spraying devices 120 in relation to the measured wind speed, thanks for example to the microcontroller 170 and the interface 101.

In this way, for example, it is possible to deactivate all of the liquid spraying devices 120 if the measured wind speed is greater than the predetermined second windspeed value.

It will therefore be possible to only activate, for example, the liquid spraying devices 120 located at the center of the plurality of photovoltaic panels. It will also be possible to adjust the spray pressure of some of the liquid spraying devices 120 according to the speed of the wind.

For example, when the wind is strong, it is preferable to spray heavy droplets of cooling liquid by lowering the spray pressure.

However, when the wind is low, the inventors have determined that it is preferable to spray fine droplets of cooling liquid by increasing the spray pressure.

In another embodiment of the invention, the device is configured to implement a method for the thermal regulation of the plurality of panels 110 illustrated by all of the steps described in figure FIG. 4.

In a first step (S300), at least one temperature of at least one photovoltaic panel 110 is measured, using the temperature sensor 130 for example. The frequency of the measurement can, for example, be controlled by the microcontroller 170.

In a second step (S310), it is measured the speed of the wind to which the plurality of photovoltaic panels 110 is exposed, using the windspeed sensor 140 for example. The frequency of the measurement can, for example, be controlled by the microcontroller 170.

In a third step (S320), it is measured the direction of the wind to which the plurality of photovoltaic panels 110 is exposed. To do this the thermal regulation device can additionally comprise means for measuring the direction of the wind, such as a wind vane for example or the like. The frequency of the measurement can, for example, be controlled by the microcontroller 170.

In a fourth step (S330), the decision is made to activate or deactivate the spraying of at least one of the liquid spraying devices 120 thanks for example to the microcontroller 170.

In order to activate or deactivate all or a part of the liquid spraying devices 120, the device is configured to additionally control the activation and/or deactivation of some of the liquid spraying devices 120 in relation to the measured wind direction thanks for example to the microcontroller 170 and the interface 101.

More specifically, it is possible to deactivate some of the liquid spraying devices 120 which are most exposed to the wind by taking into account the measured wind speed and the measured wind direction.

It will therefore be possible to only activate, for example, the liquid spraying devices 120 which are least exposed to the wind by taking into account the measured wind speed and the measured wind direction.

In another embodiment of the invention, the method for the thermal regulation of the plurality of panels 110 can be illustrated by all of the following steps:
activating the spraying of at least some of the liquid spraying devices 120 if additionally a measurement of a physical parameter at the level of the plurality of panels is greater than a predetermined first value of the physical parameter; and,
deactivating the spraying of at least some of the liquid spraying devices 120 if additionally the measurement of the physical parameter is less than or equal to a predetermined second value of the physical parameter, which is less than the predetermined first value of the physical parameter.

In one example, the physical parameter corresponds to the amount of sunlight received at the level of the plurality of panels.

In this case, for example, if the operating temperature of a photovoltaic panel 110 is high and a large cloud starts to pass over the photovoltaic panel thereby cutting the solar radiation, the spraying of at least some of the liquid spraying devices 120 can be deactivated because the panel will see its temperature decrease naturally due to the low amount of sunlight. To do this the thermal regulation device can additionally comprise means for measuring the amount of sunlight received, such as a pyranometer for example or the like.

In another example, the physical parameter corresponds to the amount of electricity produced by at least one panel.

In this case, for example, if the operating temperature of a photovoltaic panel 110 is high and the amount of electricity produced at the level of the inverter 150 decreases, for example because the solar radiation received at the level of the photovoltaic panel decreases, the spraying of at least some of the liquid spraying devices 120 can be deactivated, in order for example to save liquid, as the panel is not producing a large amount of electricity at that moment.

In another example, the physical parameter corresponds to a measurement of the electrical current and/or voltage of at least one electrical device operatively coupled to at least one panel.

In this case, for example, the measurement can be made at the level of one or more measuring points in combination such as:
at the level of the earth and/or of the ground of at least one panel;
any electrical load supplied with electricity by at least one panel such as an electrical transforming device (e.g. an inverter) or storage device (e.g. a system of electrical batteries);
an electrical network to which at least one panel is connected directly or indirectly.
   For example, at the level of an inverter, if the measured current and/or voltage reaches or approaches the “normal” operating limits of the inverter, and one or more panels are being cooled, then the spraying of at least some of the liquid spraying devices 120 can be deactivated, in order to reduce the current/voltage at the level of the inverter to prevent any overheating or other disorder of this unit, and the spraying can on the contrary be reactivated when the measured current and/or voltage has returned within the “normal” operating limit of the inverter. In another example, at the level of an electrical storage device, such as a battery for example, if the measured current and/or voltage reaches or approaches the storage saturation limit, and one or more panels are being cooled, then the spraying of at least some of the liquid spraying devices 120 can be deactivated, in order to avoid unnecessary spraying of the liquid, and the spraying can on the contrary be reactivated when the measured current and/or voltage is below the storage saturation limit, in order to accelerate the storage (e.g. battery charge for example).

In another embodiment of the invention, the method for the thermal regulation of the plurality of panels 110 can be illustrated by all of the following steps:
activating the spraying of at least some of the liquid spraying devices 120 if additionally the difference between, on the one hand the measured temperature of at least one panel and on the other hand a measurement of the ambient air temperature at the level of the plurality of panels and/or a measurement of the temperature of the cooling liquid before spraying is less than a predetermined first difference value; and,
deactivating the spraying of at least some of the liquid spraying devices 120 if additionally the difference between, on the one hand the measured temperature of at least one panel and on the other hand a measurement of the ambient air temperature at the level of the plurality of panels and/or the measurement of the temperature of the cooling liquid after spraying is greater than or equal to a predetermined second difference value, which is greater than the predetermined first difference value. To do this the thermal regulation device can additionally comprise means for measuring the ambient air temperature and/or means for measuring the temperature of the cooling liquid before and after spraying.

In this case, for example, if the ambient air temperature at the level of at least one photovoltaic panel 110 is high, for example in the vicinity of 35° C., in relation to the temperature of the photovoltaic panel 110, which might be for example in the vicinity of 25° C., the spraying of at least some of the liquid spraying devices 120 can be deactivated because trying to lower the temperature of the plurality of photovoltaic panels 110 to a level too far below the ambient air temperature would require a lot of cooling liquid. For this reason, the spraying of at least some of the liquid spraying devices 120 will be activated if the ambient air temperature is relatively cool in relation to the temperature of the photovoltaic panel 110.

Likewise, for example, if the temperature of the cooling liquid before spraying is high, for example in the vicinity of 30° C., in relation to the temperature of the photovoltaic panel 110, which might be for example in the vicinity of 25° C., the spraying of at least some of the liquid spraying devices 120 can be deactivated because trying to lower the temperature of the plurality of photovoltaic panels 110 to a level too far below the temperature of the cooling liquid before spraying might prove to be inefficient. However, the spraying of at least one of the liquid spraying devices 120 will be activated when the temperature of the cooling liquid is relatively cool in relation to the temperature of the photovoltaic panel 110.

This implementation example includes cases where the cooling liquid is recycled to assist the thermal regulation of the photovoltaic panels, for example in the context of a hydraulic system 3 in a closed cycle. This can be the case, for example, for rainwater used as cooling liquid. In this particular case, the rainwater which is collected is slightly warmed after being in contact with the photovoltaic panels. Therefore, if a limited quantity of recycled water is available, it will gradually warm up during the recycling so that the spraying of at least some of the liquid spraying devices 120 can be deactivated if the temperature of the water and/or that of the ambient air is/are high in relation to the temperature of the photovoltaic panel 110.

In another embodiment of the invention, the method for the thermal regulation of the plurality of panels 110 can be illustrated by all of the following steps:
activating the spraying of at least some of the liquid spraying devices 120 if additionally a measurement of the ambient air temperature at the level of the plurality of panels is higher than the solidification temperature of the cooling liquid; and,
deactivating the spraying of at least some of the liquid spraying devices 120 if additionally the measurement of the ambient air temperature at the level of the plurality of panels is lower than or equal to the solidification temperature of the cooling liquid.

In this case, for example, if the ambient air temperature at the level of at least one photovoltaic panel 110 is lower than the solidification temperature of the liquid, the spraying of at least some of the liquid spraying devices 120 can be deactivated because the cooling liquid runs the risk of freezing. For this reason, the spraying of at least some of the liquid spraying devices 120 will be activated only when the ambient air temperature is higher than the solidification temperature of the liquid.

In another embodiment of the invention, the method for the thermal regulation of the plurality of panels 110 can be illustrated by all of the following steps:
activating the spraying of at least some of the liquid spraying devices 120 if additionally a measurement of the atmospheric water precipitation rate at the level of the plurality of panels is less than a predetermined first atmospheric water precipitation rate value; and,
deactivating the spraying of at least some of the liquid spraying devices 120 if additionally the measurement of the atmospheric water precipitation rate at the level of the plurality of panels is greater than a predetermined second atmospheric water precipitation rate value, which is greater than the predetermined first atmospheric water precipitation rate value.

In this case, for example, the spraying of at least some of the liquid spraying devices 120 will be deactivated if it rains heavily whereas the spraying of at least some of the liquid spraying devices 120 will be activated if the atmospheric water precipitation rate is null or not very high, for example.

In another embodiment of the invention, the device is configured to measure the temperature of at least one panel by performing at least one measurement over the panel and at least one measurement underneath the panel.

Indeed, it is known that when solar radiation is received at the level of a photovoltaic panel, the upper face of the photovoltaic panel heats up quickly whereas the underside heats up much less quickly.

Therefore, it is appropriate for example to activate the spraying of at least some of the liquid spraying devices 120 when the photovoltaic panel has a hot upper face, even if the underside is still only lukewarm. And it may be appropriate, even if the upper face has become cool, to continue the spraying until the underside has also become cool. In this example, temperature sensors are installed above and underneath the plurality of photovoltaic panels.

In another embodiment of the invention, the device is configured to measure the speed and the direction of the wind for a predefined period of time in order to determine statistical values for the wind. It is clear to those skilled in the art that other statistics, such as variance or standard deviation can be taken into account. Thus, it is also possible to compare an instantaneous wind speed/direction with an average speed/direction, or with other statistical analysis results, to decide upon the activation or deactivation of at least some of the liquid spraying devices 120, and/or the spray pressure.

In another embodiment of the invention, the device is configured to determine one or more spray activation and/or deactivation moments and the spray pressure, of at least some of the spraying devices based on an algorithm to search for peaks and troughs in a model of the wind speed and/or wind direction. In this implementation example, the activation or deactivation of at least some of the liquid spraying devices 120, along with the spray pressure, is based on the detection of the cyclical nature of the wind, for example during the day. These cycles are generally marked by a directional change in the wind simultaneously with a temporary decrease in the strength of the wind. Because of this, once the duration of the cycles has been identified for example, it is often possible to predict approximately the appearance of the following occurrences and to detect more accurately their onset by observing the changes in the direction of the wind. Because of this, it will be possible for example, on the basis of a predicted occurrence moment and for a predicted occurrence time period, to compare an instantaneous wind speed/direction with an average speed/direction during the predicted occurrence to decide upon the activation or deactivation of at least some of the liquid spraying devices 120, and/or the spray pressure.

In another embodiment of the invention, the device is configured to operate with photovoltaic panels separated by a space in which the spraying devices are arranged. In this example, the liquid spraying devices 120 are coupled to one or more hydraulic conduits installed between and/or underneath the photovoltaic panels 110. These conduits are configured to convey the cooling liquid and are a part of the hydraulic system.

In another embodiment of the invention, the device is configured to modulate the activation or deactivation strategies of at least some of the liquid spraying devices 120, in relation to a reserve level of available cooling liquid.

In an embodiment of the invention, for all or a part of the meteorological and physical parameters used above to activate or deactivate at least some of the liquid spraying devices 120, it is possible to use online meteorological services accessible for example through radiofrequency or through the Internet via the microcontroller 170.

In another embodiment of the invention, the device is configured to determine one or more spray activation and/or deactivation moments and the spray pressure, for at least some of the spraying devices based on an algorithm to search for probable rates of dispersal and evaporation of the liquid in a model of the components of the evapo-dispersal phenomenon.

According to the inventors, the concept of evapo-dispersal is similar to the concept of “evapotranspiration” used for example in hydrology or in agriculture. In this phenomenon, described for example by the Penman-Monteith equation, the transpiration component is replaced by dispersal, as the photovoltaic panels 110 do not transpire like plants do. In this implementation example, the activation or deactivation of at least some of the liquid spraying devices 120 is based on the prediction of the probable rates of dispersal and evaporation in a model of the components of the evapo-dispersal phenomenon. Dispersal can, for example, depend on the characteristics of the wind, on the morphology of the plurality of photovoltaic panels and on their spatial position, as well as on the physical characteristics of the spraying. Evaporation, for its part, can depend for example on the humidity of the air, as well as on the temperature and pyranometry at the level of the plurality of photovoltaic panels.

It is specifically stated that the order of the steps of the method, that is the subject of the invention, can be modified. For example, the measurement of the wind speed and/or of the direction of the wind can be performed prior to the measurement of the temperature of at least one of the panels.

The examples disclosed above and the particular embodiments represented in the figures shall be considered as an illustration of the principles of the present invention, and should not be construed as a limitation of its aims, the scope of which is defined solely by the appended claims.

For example, the invention has been presented in the context of a photovoltaic system installed on a roof of a factory, but it is obvious that the invention can also be implemented in other places, for example on the roof of a house or in the context of a photovoltaic system on the ground. Also, the activation or deactivation of the spraying devices has been presented as being dependent on measurement(s) that are equal to, less than or greater than a predetermined value, but it is obvious that the activation or deactivation can also depend on measurements that are different from the predetermined value.

Moreover, in an embodiment of the invention, the photovoltaic panels are arranged edge to edge in vertical and/or horizontal rows following the slope of the roof of the factory so that the lower edge of a higher photovoltaic panel covers the upper edge of a lower photovoltaic panel in a row or so that a seal completes and unifies the plane formed by the panels.

In another particular embodiment of the invention, the plurality of photovoltaic panels can be replaced by a photovoltaic panel with large dimensions.

In an embodiment of the invention, other arrangements of the plurality of liquid spraying devices different from the one which has been described would be possible. For example, it would be possible to use liquid spraying devices capable of spraying a liquid that is applied onto one or more photovoltaic panels at the same time or in succession.

In an embodiment of the invention, the cooling liquid can be any liquid suitable for the cooling of a photovoltaic panel.

In another embodiment of the invention, at least one temperature sensor is associated with each photovoltaic panel or with subsets of photovoltaic panels so as to be able to measure their operating temperature independently of the other photovoltaic panels.

In an embodiment of the invention, at least one windspeed sensor is associated with each photovoltaic panel or with subsets of photovoltaic panels so as to be able to measure the speed of the wind to which they are exposed independently of the other photovoltaic panels.

In an embodiment of the invention, at least one inverter is associated with each photovoltaic panel or with subsets of photovoltaic panels through a coupling interface so as to be able to convert the current they have generated independently of the other photovoltaic panels.

In another embodiment, no inverter is used in the photovoltaic system and the amount of electricity produced by the photovoltaic system is, for example, coupled to a battery or to an electrical device configured to draw a direct current.

In another embodiment, the microcontroller is configured to control, for example, a pump of a hydraulic system, the pump and the circuit being configured to activate or deactivate one or more liquid spraying devices, and/or to adjust the operating pressure thereof.

For example, this implementation can be applied to a hydraulic system comprising at least two hydraulic circuits the first of which is configured to control a plurality of liquid spraying devices arranged in the middle of a roof and the second is configured to control a plurality of liquid spraying devices arranged on the periphery of the roof.

In this case, for example, the microcontroller would be suitable for:
activating only the first hydraulic circuit when the wind is strong; and,
activating the first hydraulic circuit and the second hydraulic circuit when the wind is low.

The control unit has been presented as being a microcontroller, however other control units such as a computer, a microprocessor, a calculator, a programmable logic controller, a servo circuit, whether electronic, mechanical and/or electromechanical, or a combination of such control units, also fall within the scope of this invention.

In another implementation example, for a photovoltaic system with a common shape, rectangular or parallelepiped, the hydraulic system might comprise five hydraulic circuits the first of which is configured to control a plurality of liquid spraying devices arranged at the center of the photovoltaic system and the other four are configured to each control a plurality of liquid spraying devices arranged respectively on one of the four edges of the photovoltaic system.

In this case, for example, the microcontroller would be suitable for:
activating all of the hydraulic circuits when the wind is low.
and, when the wind is strong, deactivating at least the one or more pluralities of spraying devices which are situated “leeward” (downwind) of the plurality of photovoltaic panels.

1. A method of thermal regulation of a plurality of photovoltaic panels (110) exposed to wind (100) and comprising a plurality of liquid spraying devices (120) suitable for applying a cooling liquid onto the plurality of panels, the method comprising the steps of:
measuring a temperature of at least one panel;
measuring the speed of the wind;
activating the spraying of at least one of the liquid spraying devices when:
the measured temperature is higher than or equal to a predetermined first temperature value; and,
the measured wind speed is less than or equal to a predetermined first windspeed value;
deactivating the spraying of all or a part of the liquid spraying devices when:
the measured temperature is lower than or equal to a predetermined second temperature value, which is lower than the predetermined first temperature value; and,
the measured wind speed is greater than or equal to a predetermined second windspeed value, which is greater than the predetermined first windspeed value;
the method being such that the activation, deactivation and/or spray pressure of some of the liquid spraying devices are controlled relative to the measured wind speed.

2. The method according to claim 1, wherein:
activation of the spraying of at least some of the liquid spraying devices is also triggered if a measurement of a physical parameter at the level of the plurality of panels is greater than a predetermined first value of the physical parameter; and,
deactivation of the spraying of at least some of the liquid spraying devices is triggered if additionally the measurement of the physical parameter is less than or equal to a predetermined second value of the physical parameter, which is less than the predetermined first value of the physical parameter;
wherein:
the physical parameter is part of a group comprising:
the amount of sunlight received at the level of the plurality of panels;
the amount of electricity produced by at least one panel; and,
the electrical current and/or voltage of at least one electrical device operatively coupled to at least one panel.

3. The method according to claim 1, further comprising:
measuring the direction of the wind;
wherein:
the activation, deactivation and/or spray pressure of at least some of the liquid spraying devices are controlled relative to the measured wind direction.

4. The method according to claim 1, wherein:
activation of the spraying of at least some of the liquid spraying devices is also triggered if the difference between the measured temperature of at least one panel and a measurement of the ambient air temperature at the level of the plurality of panels and/or a measurement of the temperature of the cooling liquid before spraying is less than a predetermined first difference value; and,
deactivation of the spraying of at least some of the liquid spraying devices is also triggered if the difference between the measured temperature of at least one panel and a measurement of the ambient air temperature at the level of the plurality of panels and/or the measurement of the temperature of the cooling liquid after spraying is greater than or equal to a predetermined second difference value, which is greater than the predetermined first difference value.

5. The method according to claim 1, wherein:
activation of the spraying of at least some of the liquid spraying devices is also triggered if a measurement of the ambient air temperature at the level of the plurality of panels is higher than a solidification temperature of the cooling liquid; and,
deactivation of the spraying of at least some of the liquid spraying devices is also triggered if the measurement of the ambient air temperature at the level of the plurality of panels is lower than or equal to the solidification temperature of the cooling liquid.

6. The method according to claim 1, wherein:
activation of the spraying of at least some of the liquid spraying devices is also triggered if a measurement of the atmospheric water precipitation rate at the level of the plurality of panels is less than a predetermined first atmospheric water precipitation rate value; and,
deactivation of the spraying of at least some of the liquid spraying devices is also triggered if the measurement of the atmospheric water precipitation rate at the level of the plurality of panels is greater than a predetermined second atmospheric water precipitation rate value, which is greater than the predetermined first atmospheric water precipitation rate value.

7. The method according to claim 1, wherein the measurement of the temperature of at least one panel is made by at least one measurement above the panel and at least one measurement underneath the panel.

8. The method according to claim 1, wherein the measurement of the speed and direction of the wind is performed for a predefined period of time in order to determine statistical values for the wind.

9. The method according to claim 1, wherein one or more spray activation and/or deactivation moments and the spray pressure for at least some of the spraying devices are determined based on an algorithm to search for peaks and troughs in a model of the wind speed and/or wind direction.

10. The method according to claim 1, wherein the panels of the plurality of photovoltaic panels are separated by a space in which the spraying devices are arranged.

11. A device for the thermal regulation of a plurality of photovoltaic panels (110) exposed to the wind (100) and comprising a plurality of liquid spraying devices (120) suitable for applying a cooling liquid onto the plurality of panels, the device comprising:
means for measuring the temperature (130) of at least one photovoltaic panel;
means for measuring the speed of the wind (140);
means for activating at least one liquid spraying device;
means for deactivating at least one spraying device,
means for controlling the pressure of at least one spraying device in relation to the measured wind speed; and,
a microcontroller coupled to at least one of the means for:
measuring the temperature of at least one photovoltaic panel;
measuring the wind speed;
activating at least one liquid spraying device;
deactivating at least one spraying device; and,
controlling the pressure of at least one spraying device in relation to the measured wind speed.

12. The device according to claim 11, further comprising, coupled to the microcontroller, at least one of the means for:
measuring the amount of sunlight received at the level of the plurality of panels;
measuring the amount of electricity produced by at least one panel;
measuring the electrical current and/or voltage of at least one electrical device operatively coupled to at least one panel;
wherein:
activation of the spraying of at least some of the liquid spraying devices is also triggered if a measurement of a physical parameter at the level of the plurality of panels is greater than a predetermined first value of the physical parameter; and,
deactivation of the spraying of at least some of the liquid spraying devices is also triggered if the measurement of the physical parameter is less than or equal to a predetermined second value of the physical parameter, which is less than the predetermined first value of the physical parameter;
and wherein:
the physical parameter is part of a group comprising:
the amount of sunlight received at the level of the plurality of panels;
the amount of electricity produced by at least one panel; and,
the electrical current and/or voltage of at least one electrical device operatively coupled to at least one panel.

13. The device according to claim 11, further comprising:
means for measuring the direction of the wind; and,
means for controlling the activation, deactivation and/or pressure of at least one spraying device in relation to the measured wind direction.

14. The device according to claim 11, further comprising at least measuring means belonging to the group consisting of:
means for measuring the ambient air temperature at the level of the plurality of panels;
means for measuring the temperature of the cooling liquid; and,
means for measuring the atmospheric water precipitation rate at the level of the plurality of panels.

15. The device according to claim 11, further comprising means for storing of at least one of the measurements obtained by the measurement means.

16. The device according to claim 11, wherein the spraying devices are coupled to one or more hydraulic conduits allowing to convey a cooling liquid and belonging to a hydraulic system.
